(19) United States
(12) Patent Application Publication
(10) Pub. No.: US 2007/0256424 A1
(43) Pub. Date: Nov. 8, 2007

(54) Heat recovery gas turbine in combined brayton cycle power generation

(75) Inventors: Michael S. Briesch, Orlando, FL (US); Ingo Weber, Spardorf (DE); Abol H. Moulavi, Oviedo, FL (US); Michael S. Briesch, Orlando, FL (US); Ingo Weber, Spardorf (DE); Abol H. Moulavi, Oviedo, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/418,862

(22) Filed: May 5, 2006

(51) Int. Cl. F02C 9/00

(52) U.S. Cl. 60/773; 60/39.182

(57) ABSTRACT

A combined Brayton cycle power plant (5). A combustion gas turbine engine (21) in the power plant uses a first Brayton cycle (20), and produces waste heat in an exhaust combustion gas (36). A heat exchanger (58) transfers the waste heat to a compressed working airflow (56) for a second Brayton cycle (50) in a heat recovery gas turbine engine (51). The heat transfer lowers the temperature of the combustion exhaust gas (36) to within an operating range of a conventional selective catalytic reduction unit (80), for efficient reduction of nitrogen oxide emissions to meet environmental regulations.

### FIELD OF THE INVENTION

This invention relates to electric power generation, especially to combined cycle power generation using a gas turbine engine in a first power cycle that produces waste exhaust heat, and a waste heat recovery system driving a second power cycle.

### BACKGROUND OF THE INVENTION

Electric power plants commonly use F-class gas turbine technology, which is distinguished by firing temperatures of about 1,300° C. and exhaust temperatures of over 580° C. A strong demand exists for turbine power plants with nitrogen oxide (NOx) emissions low enough to meet increasingly strict environmental regulations. Since gas turbines themselves do not achieve the required low emissions, NOx removal technology must be applied to the combustion exhaust gas. There are currently two main commercial alternatives for this: 1) Hot selective catalytic reduction (SCR), which can operate at the gas turbine exhaust temperature; and 2) Conventional SCR, which must operate at temperatures far below the gas turbine exhaust temperature, such as 232° C. to 370° C. Conventional SCR is preferable, due to its higher efficiency, reliability, and lower cost. Thus, technologies have been developed to reduce exhaust gas temperature to the operating range of conventional SCR. These include mixing the exhaust with ambient air, or using the hot exhaust gas in a heat recovery system that powers a subsequent power cycle such as a steam turbine.

### BRIEF DESCRIPTION OF THE DRAWINGS

The invention is explained in following description in view of the drawings that show:

FIG. 1 is a schematic view of a combined cycle power plant comprising two gas turbine generators and a conventional selective catalytic reduction unit. The second gas turbine is a heat recovery gas turbine that uses heated air for a working gas.

FIG. 2 is a schematic view as in FIG. 1 except the two gas turbines have a common power shaft and generator.

FIG. 3 illustrates the volume and temperature envelopes of a illustrative prior art Brayton cycle.

FIG. 4 is a graph of plant efficiency as a function of air compression ratio in the heat recovery gas turbine, and is based on thermodynamic modeling.

### DETAILED DESCRIPTION OF THE INVENTION

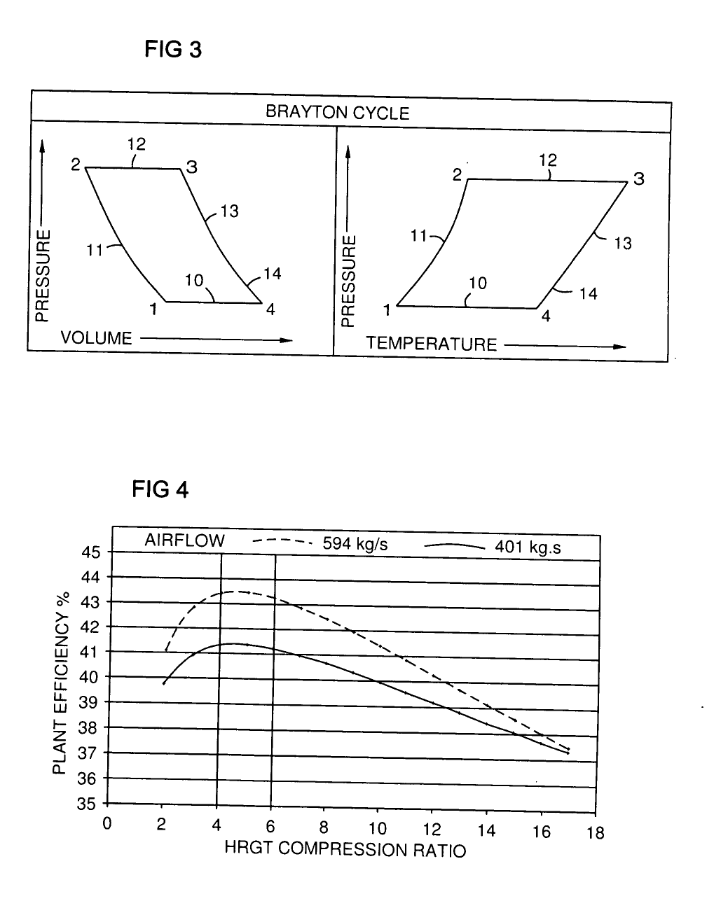

Gas turbine engines operate on a thermodynamic Brayton cycle, in which ambient air is drawn into a compressor and pressurized. The compressed air is heated in a generally constant-pressure process in a heating chamber that is open to both inflow and outflow. This is normally done by burning fuel in the compressed air in a combustion chamber, producing a hot working gas comprising combustion gasses. The heated air is then expanded through a turbine to extract energy in the form of shaft power. FIG. 3 illustrates aspects of an illustrative Brayton cycle comprising a series of transitions 1, 2, 3, and 4 of a working gas, starting from atmospheric pressure 10, then to compression 11, combustion 12, expansion through a turbine section 13, and exhaust 14.

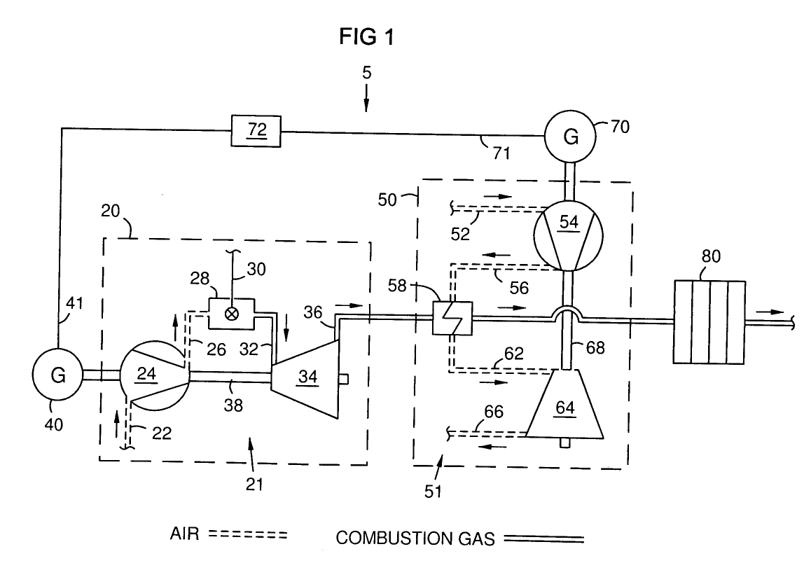

In accordance with an aspect of the invention FIG. 1 schematically shows a combined cycle power generator 5 comprising two cooperating Brayton cycles 20 and 50. The first Brayton cycle 20 may comprise a combustion turbine engine 21 with an air inlet 22, an air compressor 24, a compressed airflow 26, a combustor 28, a fuel supply 30, a compressed combustion gas flow 32, a combustion gas turbine 34, and an exhaust combustion gas flow 36. The combustion gas turbine 34 drives a power shaft 38 that drives the air compressor 24 and a generator 40, supplying electrical power 41 to a plant load 72, as known in the field of gas turbine generators.

A second Brayton cycle 50 may comprise a heat recovery gas turbine engine (HRGT) 51 comprising an air inlet 52, an air compressor 54, a compressed airflow 56, a heat exchanger 58, a compressed heated airflow 62, a hot air turbine 64, and an exhaust airflow 66. The hot air turbine 64 drives a power shaft 68 that drives the air compressor 54 and a generator 70, producing electrical power 71. The heat exchanger 58 transfers heat from the exhaust combustion gas flow 36 to the compressed airflow 56, providing heat energy for the second Brayton cycle. This recovers waste heat from the first Brayton cycle, and reduces the temperature of the exhaust combustion gas flow 36 to the operating range of a conventional selective catalytic reduction unit 80. The electrical power outputs 41 and 71 may be combined to supply the plant load 72.

In an aspect of the present invention, the heat recovery gas turbine 51 comprises a heat exchanger 58 instead of a combustion chamber 28 heating the compressed air in the generally constant-pressure process. The heat exchanger 58 transfers waste heat from the first Brayton cycle 20 to the second compressed airflow 56, producing heated compressed air 62 as the working gas. The term “gas turbine” is used generically herein for gas turbine engines with either type of heating; i.e. combustion or heat exchange, while “combustion gas turbine” is used to denote a gas turbine engine in which combustion occurs in the working gas. In either case, the compressed and heated working gas, comprising either combustion gas or air, then transfers some of its energy to shaft power by expanding through a turbine or series of turbines. Some of the shaft power extracted by the turbine is used to drive the compressor.

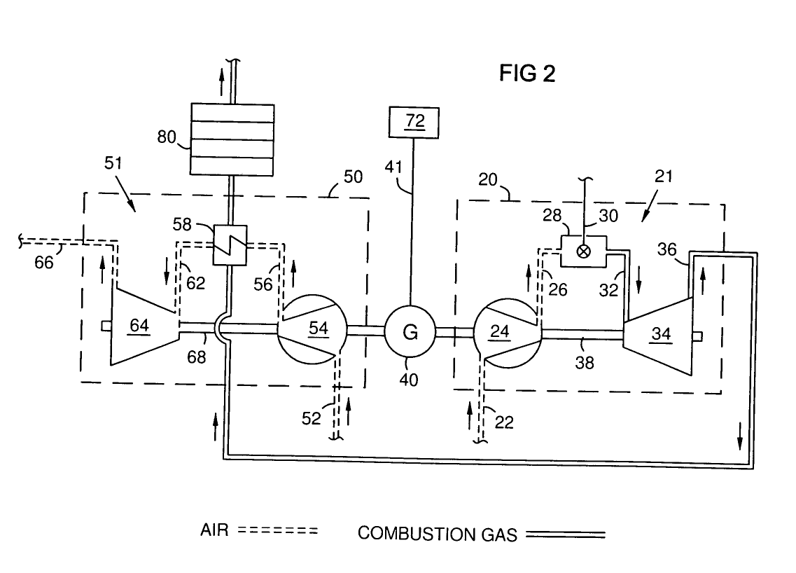

In accordance with another aspect of the invention, FIG. 2 schematically shows a combustion gas turbine engine 21 and a heat recovery gas turbine engine 51 arranged to drive a common generator 40, producing electrical power to supply a plant load 72. Power shaft transmission gearing (not shown) may be used to match the speed of both engines 21, 51 to the same generator 40, if necessary.

An important factor in the efficiency of the present invention is the HRGT compression ratio; i.e. the ratio between the outlet and inlet pressures of the HRGT compressor 54. FIG. 4 illustrates exemplary optimization curves for plant power generation efficiency as a function of the HRGT compression ratio. The two curves represent results of thermodynamic modeling at two different air mass flow rates. Typical efficiencies for the HRGT components were used in the modeling, and were held constant. This analysis shows that an optimum HRGT compression ratio falls between 4 and 6 at both flow rates.

A cost-effective means to produce an HRGT for the present invention is to use standard equipment wherever possible. An existing combustion gas turbine engine design can be modified for this purpose by replacing the combustor with a heat exchanger. Some combustion gas turbine engines have a combustion chamber in a silo connected by ducts to the gas flow of the engine. It is generally easier to replace this type of combustion chamber with a heat exchanger than to replace a can-style combustor. Typical commercially available combustion gas turbine engines have a compression ratio of over 10. One or more stages at the compressor outlet and one or more stages at the inlet of the turbine section may be removed to reduce the compression ratio of an existing gas turbine engine to a desired range for an HRGT application.

As an illustrative example of this type of implementation of the invention, a primary combustion gas turbine generator such as Siemens SGT6-5000F may be enhanced by adding a heat recovery gas turbine made by modifying a second combustion gas turbine such as Siemens SGT5-2000F. The combustion chamber of the second gas turbine may be replaced with a heat exchanger. The last 4 stages of the compressor and the first stage of the turbine section of the secondary gas turbine may be removed to achieve a pressure ratio of approximately 6. Ducting the combustion exhaust from the primary gas turbine through the heat exchanger, and operating the second gas turbine as described herein, will bring the combustion exhaust within range of conventional SCR units.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A power generator comprising:
a first Brayton cycle engine comprising a first airflow, a fuel input, and a fuel combustion in the first airflow producing combustion gas exhaust, the first Brayton cycle engine producing a first shaft power; and
a second Brayton cycle engine comprising a second airflow and a heat exchanger that transfers heat from the first combustion gas exhaust to the second airflow, the second Brayton cycle engine producing a second shaft power.

2. The power generator of claim 1, further comprising a selective catalytic reduction unit associated with the combustion gas exhaust downstream of the heat exchanger.

3. The power generator of claim 1, wherein the second airflow comprises an inlet portion, a compressed portion that passes through the heat exchanger, a heated compressed portion that leaves the heat exchanger, a portion that expands in a turbine section, and an exhaust air portion.

4. The power generator of claim 3, wherein the second airflow inlet portion comprises an inlet pressure, and the compressed portion has a pressure 4 to 6 times greater than the inlet pressure.

5. The power generator of claim 4 wherein the second Brayton cycle engine comprises a combustion gas turbine engine of a type comprising a combustion chamber and a plurality of compressor stages and modified by replacing the combustion chamber with the heat exchanger and eliminating at least one of the compressor stages and at least one of the turbine section stages.

6. The power generator of claim 1, further comprising an electrical generator, wherein the first and second shaft powers are applied to a common electrical generator.

7. A method for increasing efficiency and reducing nitrogen oxide emissions in a combustion gas turbine power generator of a type that produces a combustion gas exhaust, the method comprising:
ducting the combustion gas exhaust to a heat recovery gas turbine engine that compresses a working airflow, then transfers heat energy from the combustion gas exhaust to the working airflow, then expands the working airflow in a turbine section to produce a shaft power; and
passing the combustion gas exhaust through a selective catalytic reduction process downstream of the heat recovery gas turbine engine to reduce a nitrogen oxide emission in the combustion gas exhaust.

8. The method of claim 7, further comprising:
making the heat recovery gas turbine engine from a combustion gas turbine engine of a type comprising a combustion chamber and a plurality of compressor stages by replacing the combustion chamber with a heat exchanger and removing at least one of the compressor stages and at least one of the turbine section stages; and
ducting the combustion gas exhaust to the heat exchanger to transfer heat to the working airflow of the heat recovery gas turbine engine.

9. A power generator comprising:
a combustion gas turbine engine that draws a first airflow, compresses it, mixes it with fuel, then combusts the first airflow and fuel mixture producing a combustion gas flow, then expands the combustion gas flow in a turbine section to produce a first shaft power, then exhausts the combustion gas flow;
a heat recovery gas turbine engine that draws a second airflow, compresses it, then heats it in a heat exchanger by transferring heat from the exhausted combustion gas flow to the compressed second airflow, then expands the compressed heated second airflow in a turbine section to produce a second shaft power; and
a selective catalytic reduction unit that receives the exhausted combustion gas flow downstream of the heat exchanger.

10. The power generator of claim 9, wherein the heat recovery gas turbine engine comprises a compressor section with a compression ratio of between 4 and 6.

11. The power generator of claim 10, wherein the heat recovery gas turbine engine is designed by modifying a combustion gas turbine engine design of a type comprising a combustion chamber and a plurality of compressor stages, the modification comprising replacing the combustion chamber with the heat exchanger, and eliminating at least one of the compressor stages and at least one of the turbine section stages.

12. The power generator of claim 9, further comprising an electrical generator, wherein the first and second shaft powers are applied to a common electrical generator.
